(19) United States
(12) Patent Application Publication
(10) Pub. No.: US 2018/0133590 A1
(43) Pub. Date: May 17, 2018

(54) SYSTEM AND METHOD OF SCIENTIFIC EDUCATIONAL GAME

(71) Applicant: CATLILLI GAMES, LLC, Warrenton, VA (US)

(72) Inventor: Jonathan NARDOLILLI, Falls Church, VA (US)

(73) Assignee: CATLILLI GAMES, LLC, Warrenton, VA (US)

(21) Appl. No.: 15/809,866

(22) Filed: Nov. 10, 2017

Related U.S. Application Data
(60) Provisional application No. 62/420,924, filed on Nov. 11, 2016.

(51) Int. Cl. A63F 9/00; A63F 1/02; G09B 23/00

(52) U.S. Cl. CPC A63F 9/0076; G09B 23/00; A63F 1/02

(57) ABSTRACT

A system and method for playing an educational scavenger hunt game is provided. The system may include one or more object property testing tools and one or more object property playing cards. The method of play may include collecting gameplay objects in a scavenger hunt style, trading the gameplay objects to obtain objects with specific properties, and testing the object properties with the object property testing tools.

### CROSS-REFERENCE TO RELATED APPLICATIONS

This application claims the benefit of U.S. Provisional Patent Application Ser. No. 62/420,924, entitled “SYSTEM AND METHOD OF SCIENTIFIC EDUCATIONAL GAME”, filed Nov. 11, 2016, which is hereby incorporated herein by reference in its entirety.

### FIELD OF THE INVENTION

The invention relates to educational games, systems and apparatuses for playing educational games, and methods of playing educational games.

### BACKGROUND

Various educational games exist. Some existing educational games may involve the use of cards. Some existing educational games may involve scientific exploration activities. Conventional educational games do not combine scientific exploration activities with the competitive aspects of bartering, deception, and scavenger hunting.

### SUMMARY

The invention described provides a system that may be used to play an educational scavenger hunt game that combines scientific exploration activities with competitive bartering, deception, and scavenger hunt activities. During game play, players may collect ordinary objects in a scavenger hunt and then barter or trade the objects with one another based on fundamental properties of the objects. The system may include one or more tools for testing fundamental properties of objects, such as strength, hardness, density, etc., as well as playing cards designed to each correspond to a fundamental property and provide instructions on testing the fundamental property using the tools provided with the system. Game play may include collecting household objects, bartering and/or trading the objects, predicting properties of the objects, and testing properties of the objects.

The scientific and educational game described herein may include a game including material science activities, deception and trading. Players may receive three playing cards, each describing an object property and a means of testing the property. Players may collect household items and then receive secret objectives described by their playing cards to obtain objects with magnetic, waterproof, conductive, or other material properties. Players may trade objects until they have items that meet the requirements of two of their cards while none of their objects meets the third one. When a player meets all of their objectives, they win, unless another player puts the objects to the test and finds that they come up short.

In an implementation, a method of playing an educational game for a plurality of players is provided. The educational game may require use of a plurality of object property playing cards and a plurality of object property testing tools, wherein each of the object property playing cards indicates an object property and corresponds to one of the plurality of object property testing tools. The method may comprise collecting, by the plurality of players, a plurality of gameplay objects, wherein each of the plurality of players collects a predetermined number of gameplay objects; dealing a predetermined number of object property playing cards to each of the plurality of players; trading gameplay objects between the plurality of players; possessing, by a first player from among the plurality of players, a first gameplay object from the collected gameplay objects, and a first object property playing card from among the dealt object property playing cards; announcing, by a first player, that winning conditions have been met, the winning conditions including the first gameplay object having an object property corresponding to the object property indicated by the first object property playing card; and testing the first gameplay object with the object property testing tool corresponding to the first object property playing card.

In another implementation, a system for playing an educational game for a plurality of players is provided. The system may include a plurality of object property playing cards; and a plurality of object property testing tools, the plurality of object property testing tools including a gaming tube; wherein each of the object property playing cards includes at least an object property indicator, an object property testing tool indicator, and a graphic or written description providing instructions for use of the object property testing tool to test an object property indicated by the object property indicator, and wherein the gaming tube is configured to have a size and shape capable of containing the remainder of the plurality of object property testing tools not including the gaming tube.

These and other objects, features, and characteristics of the card-game system, the cards and methods of play disclosed herein, will become more apparent upon consideration of the following description and the appended claims with reference to the accompanying drawings, all of which form a part of this specification, wherein like reference numerals designate corresponding parts in the various figures.

### BRIEF DESCRIPTION OF THE DRAWINGS

FIG. 1 illustrates exemplary object property testing tools.

FIGS. 2a-k illustrate exemplary object property play cards consistent with the disclosure.

FIGS. 3a-b illustrate exemplary front and back sides of a product display and instruction sheet.

FIG. 4 is a flowchart depicting an exemplary process of playing an educational scientific game.

### DETAILED DESCRIPTION

The invention provides a system and method of playing a scientific educational game. The system may include a plurality of object property testing tools and a plurality of object property playing cards corresponding to object properties to be tested by the tools. Gameplay may involve the players collecting objects for testing and using the object property playing cards to determine which objects must be tested by the object property testing tools.

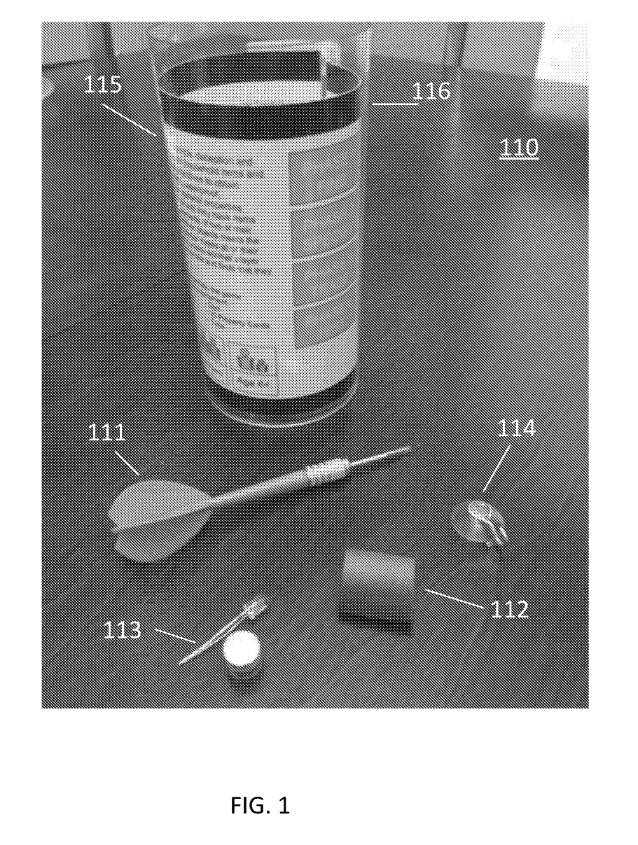

FIG. 1 illustrates exemplary object property testing tools. The educational game-play system of the present invention may include a plurality of object property testing tools 110. Object property testing tools 110 may include items specifically designed for the testing of object properties. Object property testing tools 110 may include items with other purposes that may be adapted for use as object property testing tools.

Object property testing tools 110 may include tools for testing various properties of objects, including, for example, density, hardness, strength, toughness, porosity, water resistance, magnetism, electrical conductivity, reflectivity, elasticity, roughness, smoothness, transparency, and others. A single object property testing tool 110 may be used to test more than one property of an object. For example, as described below, gaming tube 115 may be employed in several different ways to test more than one object property.

Object property testing tools 110 may include, for example, a hardness testing tool 111. Hardness is the property of a material or object to resist deformation or shape change when subject to compressive force. A hardness testing tool 111 may be a tool or item configured or adapted to test the hardness of an object. Hardness testing tool 111 may include, for example, a dart, as shown in FIG. 1. Hardness testing tool 111 may further include knives and other bladed tools, scratching tools, and any other tool suitable for testing the hardness of a material or object.

Object property testing tools 110 may include a magnetism testing tool 112. Magnetism, as used herein, refers to the property of a material or an object to be attracted to a magnet. Magnetism testing tool 112 may be a tool or item configured or adapted to test for magnetism in an object. Magnetism testing tools 112 may include, for example, a permanent ferromagnet, as shown in FIG. 1. Magnetism testing tools 112 may further include magnets of other shapes and sizes, as well as electro-magnets, and any other tool suitable for determining whether an object is attracted to a magnet.

Object property testing tools 110 may include a conductivity testing tool or tools 113. Conductivity is the property of a material to conduct electricity. A conductivity testing tool 113 may be a tool or item configured or adapted to test the electrical conductivity of an object. Conductivity testing tool 113 may include multiple parts, as illustrated in FIG. 1, and may include a battery and an LED. Conductivity testing tool 113 may further include other means of testing electrical conductivity in an object, including other types of batteries, other types of lightbulbs, conductive wires, alternate sources of current, and alternate devices that may react to conducted current.

Object property testing tools 110 may include a porosity testing tool 114. Porosity is the property of a material measuring the amount of empty space in or on the surface of a material. A porosity testing tool 114 may be a tool or item configured or adapted to test the porosity of an object. Porosity testing tool 114 may include, for example, a suction cup. A suction cup may stick to a non-porous object, but may release easily from a porous object. Porosity testing tool 114 may further include any other item or tool suitable for testing the porosity of an object.

Object property testing tools 110 may include a gaming tube 115. Gaming tube 115 may be a container configured with at least one open end. The at least one open end of gaming tube 115 may optionally be covered by a lid or other covering. Gaming tube 115 may include a closed end. In some implementations, gaming tube 115 may include a hollow cylinder with one open end, a straight-sided box with one open end, and/or any other device shaped to create a partially enclosed space capable of storing, containing, and/or transporting objects, materials, fluids, etc. Gaming tube 115 may be made of any suitable material, including plastic, nylon, acrylic, cardboard, glass, metal, etc.

In some implementations, gaming tube 115 may include partially or fully transparent and/or translucent walls 116. As illustrated in FIG. 1, gaming tube 115 may include fully transparent walls 116, such that promotional materials and gaming objects can be viewed through the walls 116. In alternative implementations, walls 116 of gaming tube 115 may be partially transparent, and may include opaque or translucent areas and transparent windows. Gaming tube 115 may be sized and shaped such that it may contain any or all of object property testing tools 110. As described below, gaming tube 115 may serve as an object property testing tools for the testing of multiple different object properties.

Gaming tube 115 may be configured of a size and shape to be capable of holding any or all of the object property testing tools (excluding the gaming tube itself) and the object property playing cards. In some implementations, gaming tube 115 the object property testing tools and the object property playing cards may be placed inside gaming tube 115 and packaged together for sale. In some implementations, gaming tube 115 may be packaged together with the object property playing cards, the object property testing tools, and a product display and information sheet 300, such that a front display side 301 of the product display and information sheet 300 is visible through transparent sides of the gaming tube 115.

Object property testing tools 110 may include a strength testing tool. Strength is the capacity of a material to withstand loads or forces without collapsing or deforming. Gaming tube 115 may be employed as a strength testing tool. For example, as explained in greater detail below with respect to strength object property playing card, gaming tube 115 may be filled with a material (e.g., water or stones), to provide a weight which may be placed on an object to test its strength. Strength testing tools may include other items or tools, including weights, pliers, vices, clamps, etc., and any other tool suitable for testing the strength of an object.

Object property testing tools 110 may include a density testing tool. Density is the mass of an object divided by the volume of the object. Gaming tube 115 may be employed as a density testing tool. For example, as explained in greater detail below with respect to the density object property playing card, gaming tube 115 may be filled with a fluid, e.g., water, to provide a medium against which to test the density of an object. A floating object is less dense than water, while a sinking object may be more dense. Density testing tools may further include any other items suitable for testing the density of an object.

Object property testing tools 110 may include a roughness testing tool. Roughness is a measure of the variance of an object surface. Gaming tube 115 may be employed as a roughness testing tool. For example, as explained in greater detail below with respect to the roughness object property playing card, gaming tube 115 may be employed as a slide to test the roughness of an object. Roughness testing tools may further include any object suitable for testing the roughness of an object.

Object property testing tools 110 may include a waterproof testing tool. Waterproofness is a measure of an objects tendency to repel, rather than soak up, water. Gaming tube 115 may be employed as a waterproof testing tool. For example, as explained in greater detail below with respect to the waterproof object property playing card, gaming tube 115 may be filled with water for immersing an object in. It may then be tested how waterproof the immersed object is. Waterproof testing tools may further include any object suitable for testing the waterproofness of an object.

Object property testing tools 110 may include a reflectivity testing tool. Reflectivity of an object is a measure of how well the object reflects light. A reflectivity object property playing card may be used as a reflectivity testing tool, as explained in greater detail below. Other reflectivity testing tools may include printed cards or other materials, colored chips, cards or other objects, books, and/or any other object suitable for testing the reflectivity of an object.

Object property testing tools 110 may include an elasticity testing tool. Elasticity measures the property of an object to stretch and return to an original size without damage. Gaming tube 115 may be employed as an elasticity testing tool. For example, as explained in greater detail below with respect to the elasticity object property playing card, gaming tube 115 may be used as a baseline measuring tool to test an amount of elastic stretch. Other elasticity testing tools may further include any object suitable for testing the elasticity of an object.

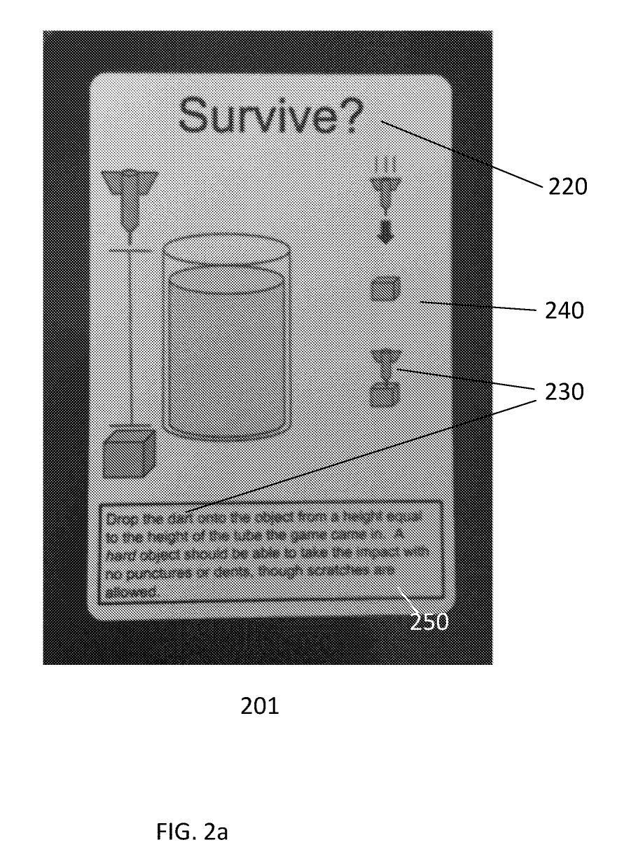

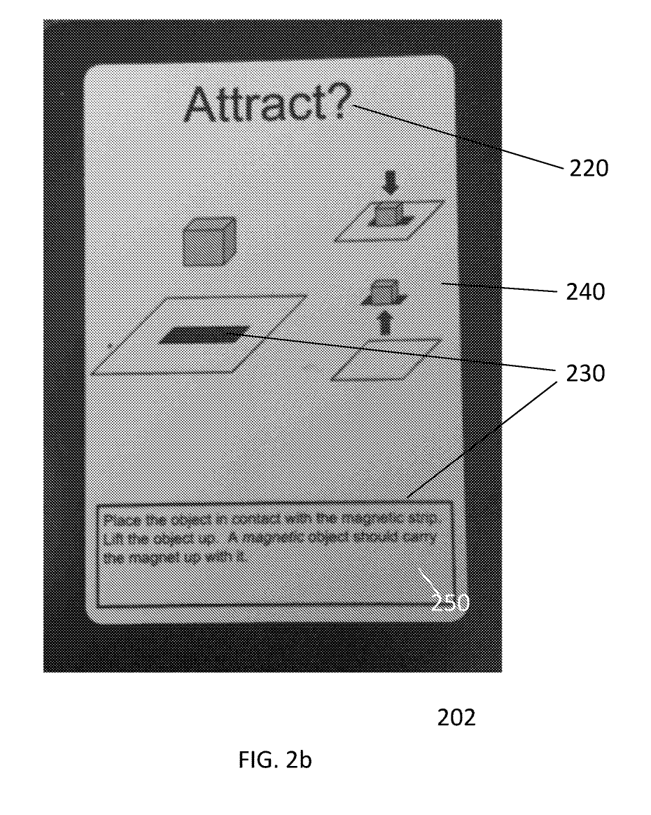

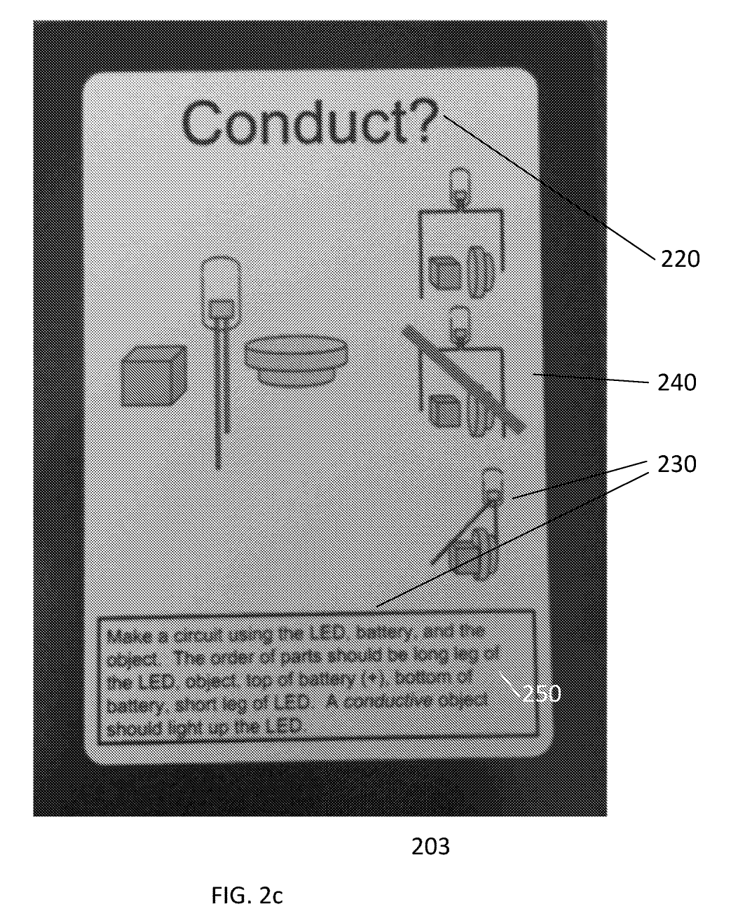

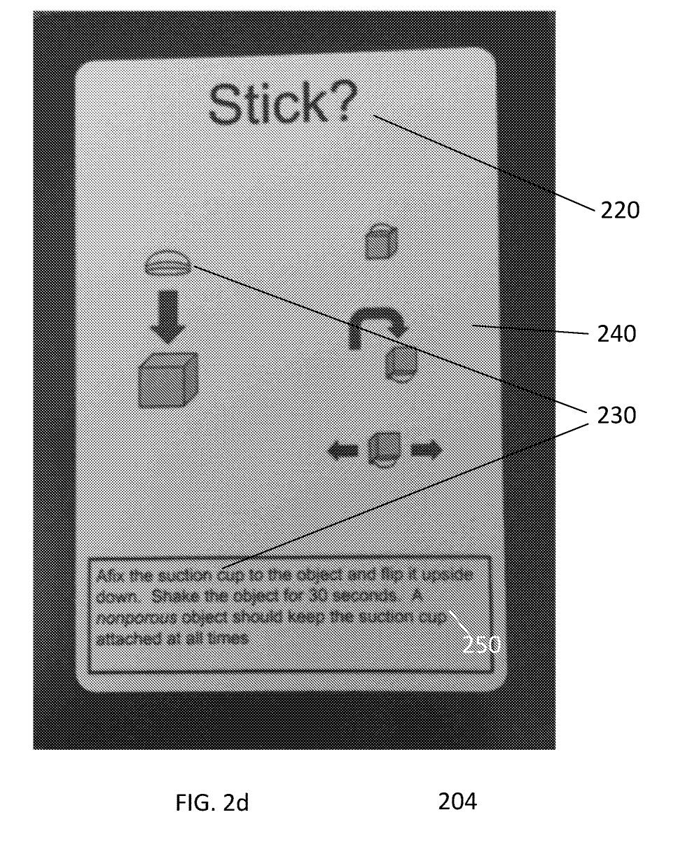

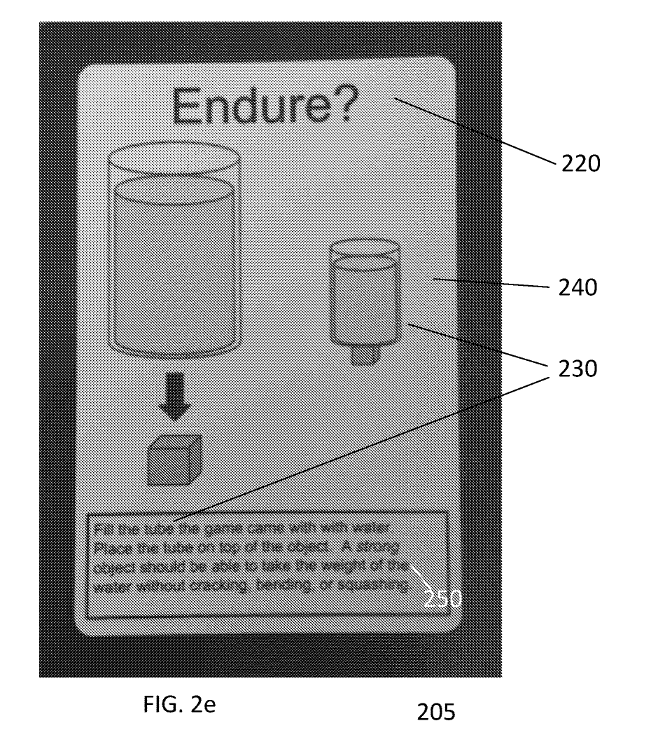

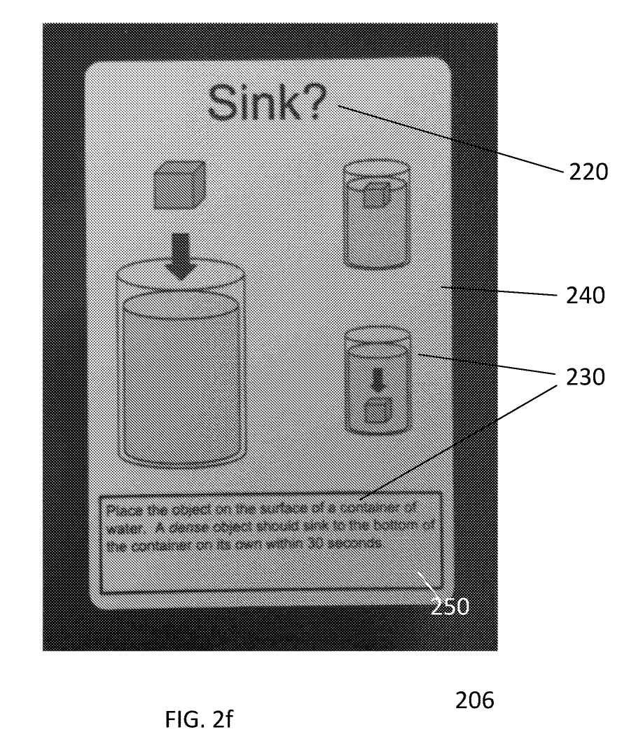

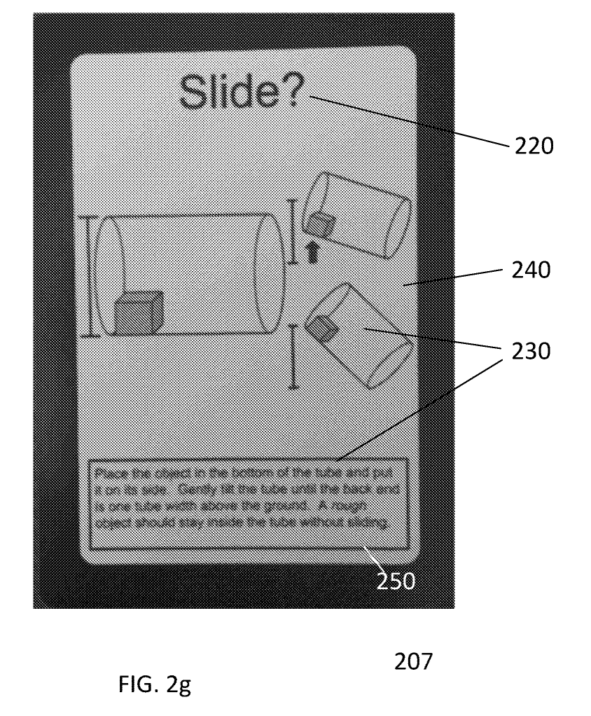

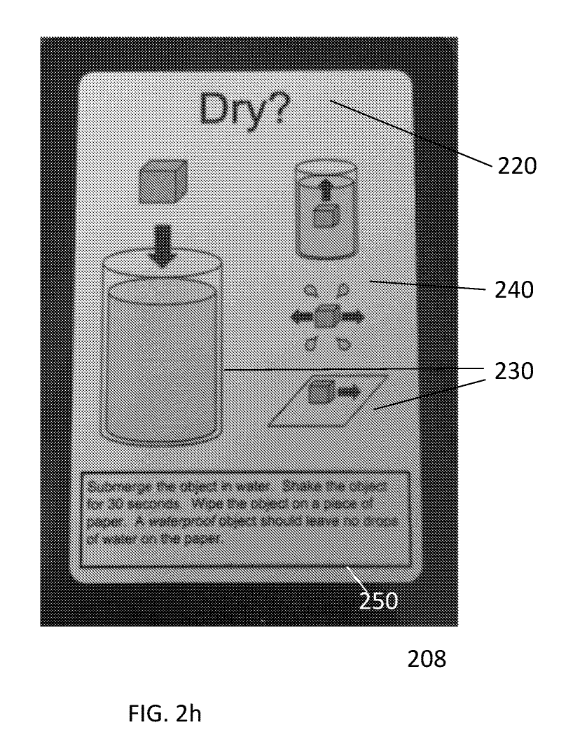

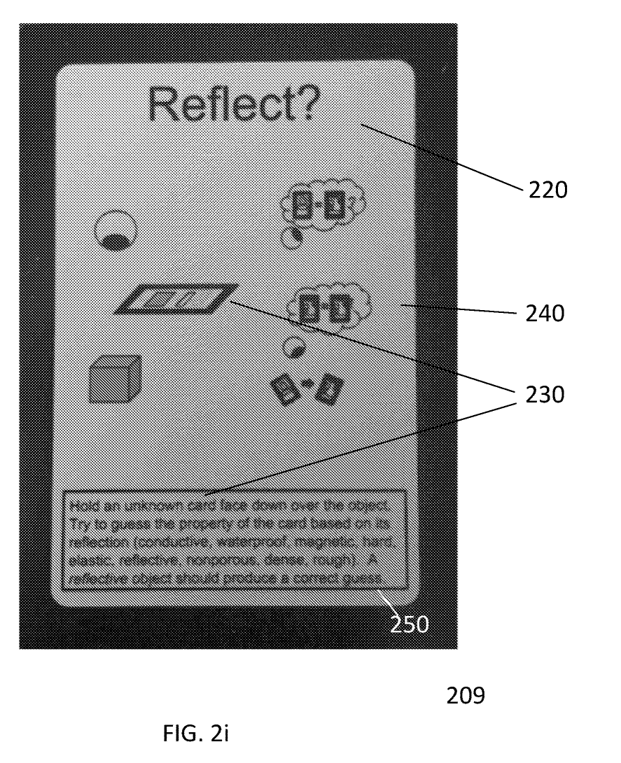

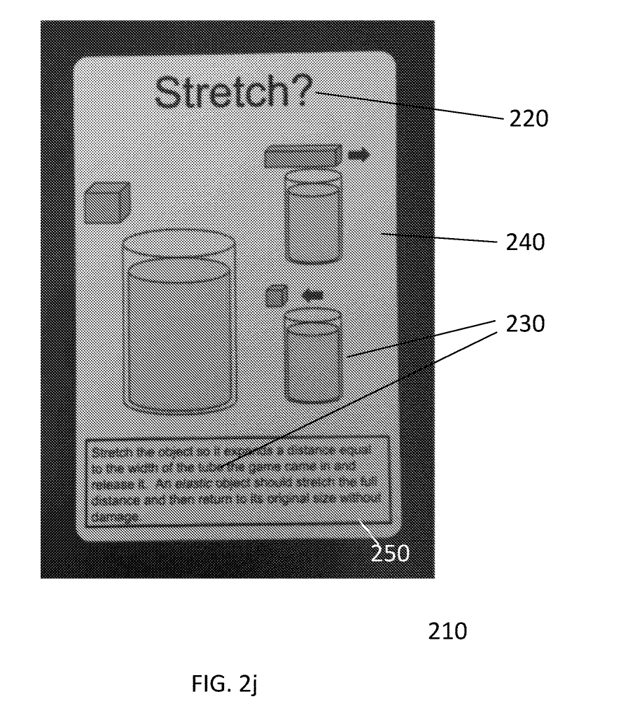

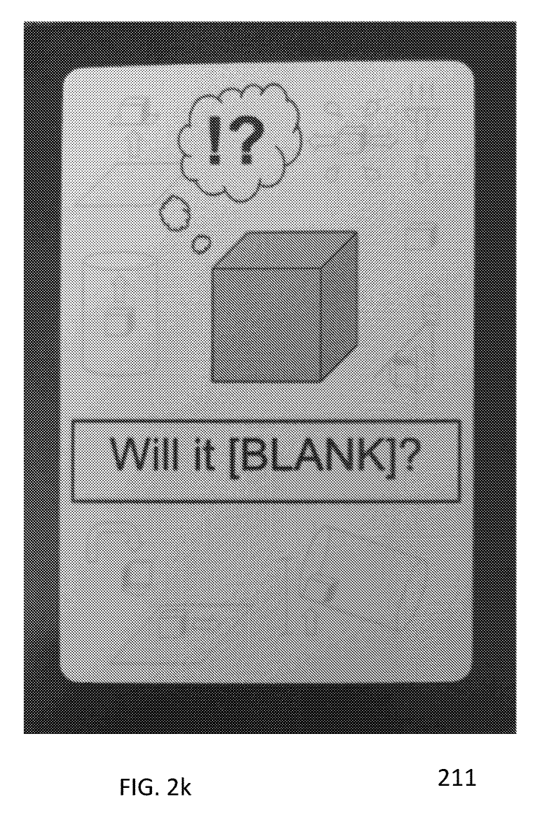

FIGS. 2a-k illustrate exemplary object property play cards consistent with the disclosure. Object property display cards may each correspond to an object property. Object property display cards may each include instructions for using an object property testing tool 110 to test an object property corresponding to that of the card of a gameplay object.

The object property playing cards, and the instructions provided thereon, as illustrated in FIGS. 2a-k are exemplary only. Object property playing cards may each include markings and/or other indicia describing or otherwise illustrating an associated object property. Markings on the card, e.g., text or illustrations, may provide gameplay testing instructions for testing the object property associated with the card of a gameplay object, using one or more object property testing tools 110. Each object property playing card may include an object property indicator 220, one or more object property testing tool indicators 230, and graphic and/or written descriptions providing instructions to use the object property testing tool for testing the indicated object property. Object property indicators may include words that indicate an object property to be tested. Object testing tool indicators may include graphical illustrations of an object testing tool and/or words describing an object testing tool.

FIG. 2a illustrates a hardness object property playing card 201. Hardness object property playing card 201 provides instructions for gameplay actions related to hardness object property playing card 201. Hardness object property playing card 201 may detail the use of a hardness testing tool 111. As illustrated in FIG. 2a, a hardness object property playing card 201 may instruct a player to drop a hardness testing tool 111 onto an object to test the hardness of the object. Hardness object property playing card 201 may include object property indicator 220, one or more object testing tool indicators 230, graphical instructions 240, and written instructions 250.

FIG. 2b illustrates a magnetism object property playing card 202. Magnetism object property playing card 202 may provide instructions for gameplay actions related to magnetism object property playing card 202. Magnetism object property playing card 202 may detail the use of a magnetism testing tool 112. As illustrated in FIG. 2b, a magnetism object property playing card may instruct a player to test an object's magnetic properties by determining whether magnetic testing tool 112 will stick to the object. Magnetism object property playing card 202 may include object property indicator 220, one or more object testing tool indicators 230, graphical instructions 240, and written instructions 250.

FIG. 2c illustrates a conductivity object property playing card 203. Conductivity object property playing card 203 provides instructions for gameplay actions related to conductivity object property playing card 203. Conductivity object property playing card 203 may detail the use of a conductivity testing tool 113. As illustrated in FIG. 2c, a conductivity object property playing card 203 may instruct a player to test conductivity of an object by building an electrical circuit with the object and the conductivity testing tool 113. Conductivity object property playing card 203 may include object property indicator 220, one or more object testing tool indicators 230, graphical instructions 240, and written instructions 250.

FIG. 2d illustrates a porosity object property playing card 204. Porosity object property playing card 204 provides instructions for gameplay actions related to porosity object property playing card 204. Porosity object property playing card 204 may detail the use of a porosity testing tool 114. As illustrated in FIG. 2d, a porosity object property playing card may instruct a player to test porosity of an object by determining whether a porosity testing tool 114 will stick to the object. Porosity object property playing card 204 may include object property indicator 220, one or more object testing tool indicators 230, graphical instructions 240, and written instructions 250.

FIG. 2e illustrates a strength object property playing card 205. Strength object property playing card 205 provides instructions for gameplay actions related to strength object property playing card 205. Strength object property playing card 205 may detail the use of a gaming tube 115 as a strength testing tool. As illustrated in FIG. 2e, a strength object property playing card may instruct a player to place a weighted gaming tube 115 atop an object to test the strength of the object. Strength object property playing card 205 may include object property indicator 220, one or more object testing tool indicators 230, graphical instructions 240, and written instructions 250.

FIG. 2f illustrates a density object property playing card 206. Density object property playing card 206 provides instructions for gameplay actions related to density object property playing card 206. Density object property playing card 206 may detail the use of a gaming tube 115 or other container as a density testing tool. As illustrated in FIG. 2f, a density object property playing card may instruct a player to drop to test the density of an object by placing it in water to determine whether it sinks or floats. Density object property playing card 206 may include object property indicator 220, one or more object testing tool indicators 230, graphical instructions 240, and written instructions 250.

FIG. 2g illustrates a roughness object property playing card 207. Roughness object property playing card 207 provides instructions for gameplay actions related to roughness object property playing card 207. Roughness object property playing card 207 may detail the use of gaming tube 115 as a roughness testing tool. As illustrated in FIG. 2g, a roughness object property playing card may instruct a player to use gaming tube 115 as an inclined plane to test a roughness of an object. Roughness object property playing card 207 may include object property indicator 220, one or more object testing tool indicators 230, graphical instructions 240, and written instructions 250.

FIG. 2h illustrates a waterproofness object property playing card 208. Waterproofness object property playing card 208 provides instructions for gameplay actions related to waterproofness object property playing card 208. Waterproofness object property playing card 208 may detail the use of gaming tube 115 and a sheet of paper as a waterproofness testing tool. As illustrated in FIG. 2h, a waterproofness object property playing card 208 may instruct a player to use gaming tube 115 as a source of water with which to test the water absorption properties of an object. Waterproofness object property playing card 208 may include object property indicator 220, one or more object testing tool indicators 230, graphical instructions 240, and written instructions 250.

FIG. 2i illustrates a reflectivity object property playing card 209. Reflectivity object property playing card 209 provides instructions for gameplay actions related to reflectivity object property playing card 209. Reflectivity object property playing card 209 may detail the use of an object property playing card as a reflectivity testing tool. As illustrated in FIG. 2i, a reflectivity object property playing card 209 may instruct a player to attempt to read text of reflectivity object property playing card 209 via a reflection from an object to test reflectivity. Reflectivity object property playing card 209 may include object property indicator 220, one or more object testing tool indicators 230, graphical instructions 240, and written instructions 250.

FIG. 2j illustrates a elasticity object property playing card 210. Elasticity object property playing card 210 provides instructions for gameplay actions related to elasticity object property playing card 210. Elasticity object property playing card 210 may detail the use of gaming tube 115 as an elasticity testing tool. As illustrated in FIG. 2j, a elasticity object property playing card 210 may instruct a player to use gaming tube 115 as a measurement tool for determining object elasticity. Elasticity object property playing card 210 may include object property indicator 220, one or more object testing tool indicators 230, graphical instructions 240, and written instructions 250.

FIG. 2k illustrates exemplary markings for a back 211 of an object property playing card.

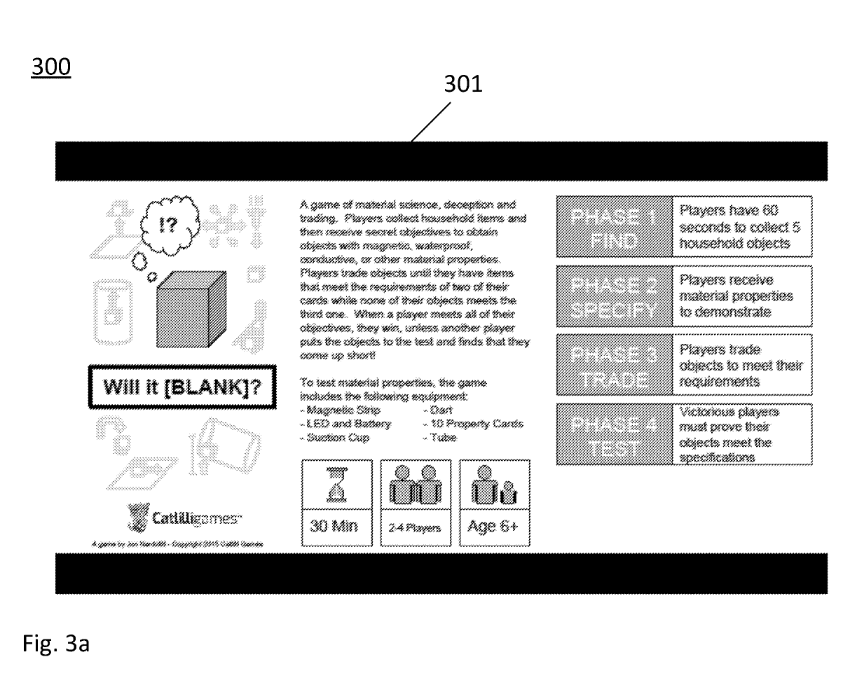

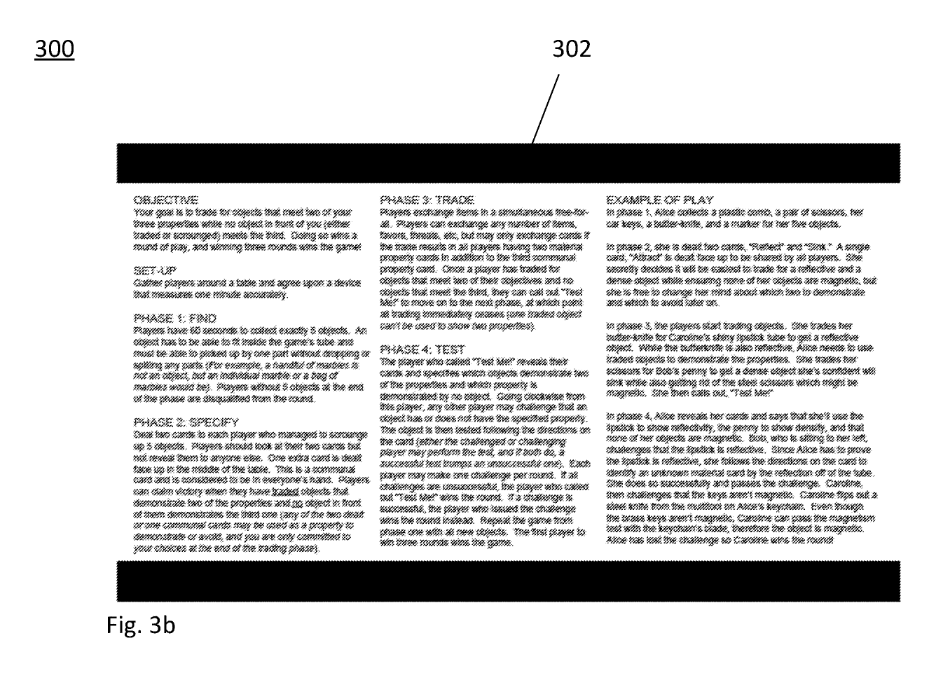

FIGS. 3a-b illustrate exemplary front and back sides of product display and instruction sheet 300. Product display and instruction sheet 300 may be sized and shaped so as to fit inside gaming tube 115, e.g., as illustrated in FIG. 1. Product display and information sheet 300 may include a front side 301 bearing display information about the game and a back side 302 bearing instructional information about the game. A front side 301 of product display and information sheet 300 may include a description of the scientific educational game, “Will it [Blank]?” A rear side 302 of product display and information sheet 400 may include gameplay instructions.

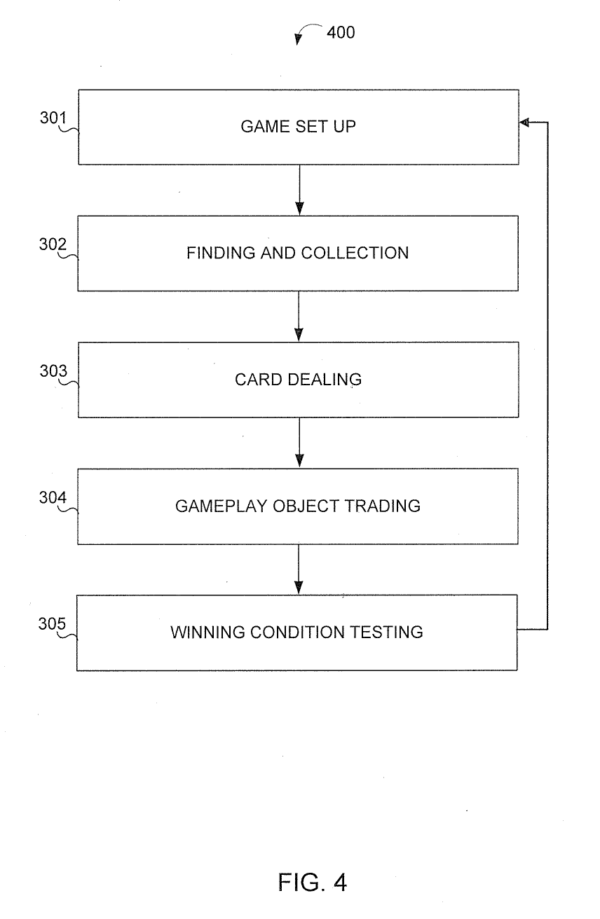

FIG. 4 is a flowchart depicting an exemplary process 400 of playing an educational scientific game. The objective of the game is to collect, trade for, or otherwise obtain gameplay objects that satisfy one or more of a player's object property playing cards without obtaining any objects that satisfies a different one or more of a player's object property playing card. Doing so wins a round of play, and winning three rounds wins the game.

In a set up step 301, process 400 includes game play set up. Game play set up includes gathering all players together and selecting a timing device. A selected timing device may be capable of accurately timing one minute.

In a finding step 302, process 400 includes a game play object finding step. Players of the game each have a predetermined amount of time to collect a predetermined number of objects, to be designated as gameplay objects. To qualify as a gameplay object, each object must fit inside gaming tube 115 and must be capable of being lifted by one part without dropping or spilling any parts. (For example, a handful of marbles is not a gameplay object, but an individual marble or a bag of marbles is). Players that fail to collect the predetermined number of objects are disqualified from the game play round. In an exemplary implementation, a predetermined amount of time is sixty seconds and a predetermined number of objects is five, although other lengths of time and other amounts of objects are within the scope of the invention.

In a dealing step 303, process 400 includes dealing of cards. A predetermined number of cards may be dealt to each player that successfully collected the predetermined number of objects. Players shall possess the cards that have been dealt to them. Players should look at their two cards but not reveal them to anyone else. One or more communal cards may then be dealt face up to the center of play area. The communal cards are considered to be part of every player's hand, i.e., possessed by every player simultaneously. In an exemplary implementation, each player may be dealt two cards and a single card may be dealt face up in the game play area as a communal card. Game play is not limited to this distribution of cards, however, and other card distributions are contemplated without departing from the scope of the invention.

In a trading step 304, process 400 includes game play object trading. During game play object trading, players may exchange game play objects with each other. Game play object trading may take place simultaneously between all players. Players may exchange any number of game play objects. Players may exchange non-game elements, including favors and threats. Players may only exchange cards if a trade results in all players have the same predetermined number of object property cards with which they began the game. Players may continue to trade game play objects and object property playing cards until they meet the round winning conditions.

Round winning conditions may include the possession of at least one game play object exhibiting properties of each of one or more of a player's object property cards while not owning any objects that exhibit the properties of a different one or more of the player's object property cards. In an exemplary embodiment, each player must collect at least one game play object exhibiting a material property corresponding to two of the player's object property cards while not collecting any objects that exhibit material properties associated with the third of the player's object property cards. In one implementation, one game play object may only be used to exhibit one object property. In an implementation, the collected game play objects satisfying the object property playing cards must be game play objects that have been traded for by the announcing player, rather than game play objects collected at the start of the game by the announcing player. In an implementation, game play objects that have been traded for may include game play objects that were collected at the start of the game by the announcing player, traded away in a first trade, and then traded for again in a second trade. In an implementation, a second trade and a first trade must include at least one game play object that differs.

When a player believes that their trading has successfully met the round winning conditions, they may end the trading step 304 of the game by announcing that they have me the conditions with a predetermined testing word or phrase. For example, a player may announce “test me,” “I win,” “I'm done,” or any other suitable predetermined phrase. Once a player has announced the predetermined phrase, the trading step 304 ends and all trading must cease.

In a testing step 305, process 400 includes a step of object property testing. The player that announced the testing phrase may reveal their cards and specify which of their gameplay objects correspond to their object property playing cards and which of their object property playing cards does not correspond to any of the their gameplay objects. Play may then proceed clockwise from the announcing player. Each player, in turn, may challenge a gameplay object of the announcing player.

Challenging a gameplay object may include testing a property of the gameplay object. For gameplay objects designated by the announcing player as having an object property, the gameplay object may be tested according to the instructions on the corresponding object property playing card. For gameplay objects designated as not having an object property, the game play object may be tested according to the instructions on the corresponding object property card. Either or both of the announcing player or the challenging player may perform the test. If one test is successful (indicating a gameplay object has the property being tested for) and a second test is unsuccessful, a predetermined tiebreaking rule may be employed. A predetermined tiebreaking rule may favor successful test in the case of conflicting results, or may favor the unsuccessful test in the case of conflicting results.

Each player may issue one challenge per round. If the announcing player wins all challenges, i.e., all of their gameplay objects successfully test for the properties they are announced to have and unsuccessfully test for the properties they are announced not to have, the announcing player wins the round. If the announcing player's gameplay objects fail a challenge, than the challenging player wins the round. A winner of the game may be a player that wins a predetermined number of rounds.

In an implementation, a round of play may proceed as follows. In a finding step 302, Alice collects a plastic comb, a pair of scissors, her car keys, a butter-knife, and a marker for her five objects. In a dealing step 303, she is dealt two reflectivity object property card and the density object property card. The magnetism object property card is dealt face up to be shared by all players. She secretly decides it will be easiest to trade for a reflective and a dense object while ensuring none of her objects are magnetic, but she is free to change her mind about which two to demonstrate and which to avoid later on. In a trading step 304, the players start trading objects. She trades her butter knife for Caroline's shiny lipstick tube to get a reflective object. While the butter knife is also reflective, Alice must use traded objects to demonstrate the properties. She trades her scissors for Bob's penny to get a dense object she's confident will sink while also getting rid of the steel scissors which might be magnetic. She then calls out, “Test Me!” In testing step 305, Alice reveals her cards and says that she'll use the lipstick to show reflectivity, the penny to show density, and that none of her objects are magnetic. Bob, who is sitting to her left, challenges that the lipstick is reflective. Since Alice has to prove the lipstick is reflective, she follows the directions on the card to identify an unknown material card by the reflection off of the tube. She does so successfully and passes the challenge. Caroline, then challenges that the keys aren't magnetic. Caroline flips out a steel knife from the multitool on Alice's keychain. Even though the brass keys aren't magnetic, Caroline can pass the magnetism test with the keychain's blade, therefore the object is magnetic. Alice thus loses the challenge and Caroline wins the round. Gameplay may proceed according to the above description until one player has won a predetermined number of rounds, e.g., 3, 5, 7, or any suitable number.

The foregoing detailed description of the invention has been presented for purposes of illustration, and is not intended to be exhaustive or limited to the invention in the form disclosed. Variations and modification of the embodiments described herein will be apparent to those of ordinary skill in the art, and it is understood that the invention may be practiced in a manner other than what is specifically described herein without departing from the spirit and/or scope of the disclosure.

What is claimed is:

1. A system for playing an educational game for a plurality of players, the system comprising:
a plurality of object property playing cards;
a plurality of object property testing tools, the plurality of object property testing tools each being configured for testing at least one property of an object, and the plurality of object property testing tools including a gaming tube;
wherein each of the object property playing cards includes at least an object property indicator, an object property testing tool indicator, and a graphic or written description providing instructions for use of the object property testing tool to test an object property indicated by the object property indicator, and
wherein the gaming tube is configured to have a size and shape capable of containing the remainder of the plurality of object property testing tools not including the gaming tube.

2. The system of claim 1, wherein the object property testing tools include a hardness testing tool and the plurality of object property playing cards include a hardness object property card including instructions for testing a hardness property of an object.

3. The system of claim 1, wherein the object property testing tools include a magnetism testing tool and the plurality of object property playing cards include magnetism object property card including instructions for testing a magnetism property of an object.

4. The system of claim 1, wherein the object property testing tools include a conductivity testing tool and the plurality of object property playing cards include a conductivity object property card including instructions for testing a conductivity property of an object.

5. The system of claim 1, wherein the object property testing tools include a porosity testing tool and the plurality of object property playing cards include a porosity object property card including instructions for testing a porosity property of an object.

6. The system of claim 1, wherein the gaming tube is packaged for sale containing the remainder of the plurality of object property testing tools not including the gaming tube.

7. The system of claim 1, wherein the gaming tube is packaged for sale containing the plurality of object property playing cards.

8. The system of claim 1, further comprising a product display and instruction sheet having a first product display side and a second instructional side,
wherein a first side of the product display and instruction sheet includes product display markings and a second side of the product display and instruction sheet includes gameplay instructions,
the gaming tube includes at least partially transparent walls; and
wherein the gaming tube is packaged for sale containing the plurality of object property playing cards, the remainder of the plurality of object property testing tools not including the gaming tube, and the product display and instruction sheet such that to product display side of the product display and instructional sheet is visible through the at least partially transparent walls of the gaming tube.

9. A method of playing an educational game for a plurality of players, the educational game requiring the use of a plurality of object property playing cards and a plurality of object property testing tools, wherein each of the object property playing cards indicates an object property and corresponds to one of the plurality of object property testing tools, the method comprising:
collecting, by the plurality of players, a plurality of gameplay objects, wherein each of the plurality of players collects a predetermined number of gameplay objects;
dealing a predetermined number of object property playing cards to each of the plurality of players;
trading gameplay objects between the plurality of players;
possessing, by a first player from among the plurality of players, a first gameplay object from the collected gameplay objects, and a first object property playing card from among the dealt object property playing cards;
announcing, by a first player, that winning conditions have been met, the winning conditions including the first gameplay object having an object property corresponding to the object property indicated by the first object property playing card; and
testing the first gameplay object with the object property testing tool corresponding to the first object property playing card.

10. The method of claim 9, the method further comprising:
challenging, by a second player from the plurality of players, that the first gameplay object corresponding to the first object property playing card does not have the object property corresponding to the first object property playing card.

11. The method of claim 10, the method further comprising:
determining, responsive to the testing, that the first gameplay object has the object property corresponding to the first object property playing card; and
determining that the first player is a winner responsive to the determination that the first gameplay object has the object property corresponding to the first object property playing card.

12. The method of claim 10, the method further comprising:
determining, responsive to the testing, that the first gameplay object does not have the object property corresponding to the first object property playing card; and
determining that the second player is a winner responsive to the determination that the first gameplay object has the object property corresponding to the first object property playing card.

13. The method of claim 9, wherein testing the first gameplay object further includes testing the first gameplay object with the object property testing tool corresponding to the first object property playing card according to a method described on the first object property playing card.

14. The method of claim 9, the method further comprising:
trading object property playing cards among the plurality of players.

15. The method of claim 9, wherein trading gameplay objects includes trading to obtain the first gameplay object by the first player.

16. The method of claim 9, the method further comprising:
possessing, by the first player, a second gameplay object from the collected gameplay objects, and a second object property playing card from among the dealt object property playing cards,
wherein the winning conditions include the second gameplay object having an object property corresponding to the object property indicated by the second object property playing card.

17. The method of claim 9, the method further comprising:
possessing, by the first player, a plurality of additional gameplay objects from the collected gameplay objects, and a third object property playing card from among the dealt object property playing cards,
wherein the winning conditions include the first gameplay object and the plurality of additional gameplay objects not having an object property corresponding to the object property indicated by the third object property playing card.

18. The method of claim 9, the method further comprising:
dealing a communal object property card to be possessed by all players.
